(19) United States
(12) Patent Application Publication
(10) Pub. No.: US 2008/0191103 A1
(43) Pub. Date: Aug. 14, 2008

(54) Clip

(76) Inventor: Lorne Thurgar, Queensland (AU)

Correspondence Address: DILWORTH & BARRESE, LLP, 333 EARLE OVINGTON BLVD., SUITE 702, UNIONDALE, NY, 11553, US

(21) Appl. No.: 11/885,511

(22) PCT Filed: Feb. 10, 2006
(86) PCT No.: PCT/AU06/00177

§ 371 Date: Aug. 31, 2007

(30) Foreign Application Priority Data
Mar. 1, 2005 (AU) 2005100176

(51) Int. Cl. F16B 2/22

(52) U.S. Cl. 248/101

(57) ABSTRACT

A resiliently deformable clip (10) for holding a liner (120) in a garbage bin (130) has an inner leg (50) and an outer leg (20) that clips over a lip (110) of the bin (130). A ridge (30) formed on the surface of the outer leg (20) catches under the lip (110) to hold the clip (10) in place. A grip (25) on the outer leg (20) allows the clip (10) to be removed without reaching into the bin (130).

### FIELD OF THE INVENTION

The invention relates to a clip for securing a bag. In particular, although not exclusively, the invention relates to an apparatus and method for securing a bag within a receptacle.

### BACKGROUND TO THE INVENTION

It is common for individuals to use bin liners or garbage bags to line the inside of their garbage bins. Having a liner, generally disposable, allows the bin to be emptied simply by removing the liner from the bin. When an individual does not employ a bin liner the entire bin has to be taken to either a larger bin or a rubbish dump. Further, when the bin is emptied there is a high likelihood that any garbage that was liquid or viscus will remain inside the bin requiring a time consuming and unpleasant cleaning. Any rubbish that is not fully removed from the bin may begin to decompose and the area surrounding the bin will be subject to an extremely unpleasant smell and there will be a higher likelihood of insects, especially flies, gathering around the bin.

Unfortunately, bin liners commonly tear or detach from a lip of the bin and fall into the bin. Following this, it is quite likely that the bin liner will not capture any rubbish that is placed in the bin. When this occurs it will be required that the bin be extensively cleaned.

To prevent bin liners detaching from the lips of bins a number of prior art clips have been developed. U.S. Pat. No. 6,484,374 discloses a flexible clamp device for securing a pliable bag to a container. The invention includes a clasping unit that is secured to the device when a pair of arms is in place over the bin lip. The clasping unit applies sufficient pressure to ensure that the clamp is securely attached to the bin lip. A second embodiment of the invention describes a one-piece clamp that deforms slightly to attach to the lip of a bin. Unfortunately, it is required that an individual reach into the bin to remove or attach the clamp. This creates the risk that the individual will come into contact with some of the contents of the bin and possibly a large amount of bacteria, a proposition that many individuals find to be to their distaste.

United Kingdom patent 2,158,138 discloses a clip for attaching a flexible liner bag. The clip is produced from a single synthetic plastics moulding and comprises a tongue and a surrounding part. The clip requires that an individual who is removing the clip grasp the clip by the tongue and a section of a back of the surrounding part that protrudes above the bin, this unfortunately requires that the individual place their hands within the bin, again raising hygiene issues.

U.S. Pat. No. 5,735,495 discloses a trash bag holding device that comprises a clip that is placed over the rim of a receptacle. An arm of the clip that is against an inside of the receptacle has a flap attached that can snap into a cavity in the main body of the arm, between which a trash bag can be retained to secure the bag in the receptacle. To operate the flap of this invention it is required that an individual place their hands completely inside the bin, exposing them to bacteria. Another disadvantage of this invention is the relatively small surface area of the trash bag that is clasped by the flaps. This creates a risk that when a trash bag is ill fitting or a large amount of trash is placed within the trash bag that the bag will tear around the snaps and the trash will spill into the receptacle.

### OBJECT OF THE INVENTION

It is an object of the present invention to address or at least ameliorate one or more of the aforementioned problems associated with the prior art or to provide a useful commercial alternative.

It is a further object to provide an hygienic means of holding a garbage bag in a garbage bin.

### DISCLOSURE OF THE INVENTION

In one form, although it need not be the only or indeed the broadest form, the invention resides in a clip comprising:

an inner leg joined to an outer leg;

a grip formed by a lower portion of the outer leg extending away from the inner leg; and

a catch formed by a ridge on a surface of the outer leg facing the inner leg;

wherein the outer leg is resiliently deformable with respect to the inner leg.

Preferably, the clip incorporates a bridge that joins the inner leg and the outer leg.

At least part of the clip is preferably formed from resiliently deformable plastics material.

In another form, the invention resides in a method of securing a garbage bag within a garbage bin with the aid of one or more clips, including the steps of:

placing the garbage bag within the bin such that a portion of the garbage bag rests over a lip of the bin;

placing one or more clips over the lip of the bin by holding the clips by the grip such that an inner leg rests against an inner wall of the bin and the outer leg rests against an outer wall of the bin; and

securing one or more clips by securing the catch beneath the lip of the garbage bin.

In a further form, the invention resides in a method of removing a garbage bag that is secured with one or more clips from within a garbage bin, including the steps of:

removing one or more clips from the lip of the bin by holding the clips by a grip and applying pressure so as to release a catch from beneath an outer edge of the garbage bin and lifting the clip from the bin; and

removing the garbage bag from within the garbage bin.

Further features of the present invention will become apparent from the following detailed description.

### BRIEF DESCRIPTION OF THE DRAWINGS

To assist in understanding the invention and to enable a person skilled in the art to put the invention into practical effect preferred embodiments of the invention will be described by way of example only with reference to the accompanying drawings, wherein:

FIG. 1 shows a perspective view of a first embodiment of a garbage bin clip;

FIG. 2 shows a profile view of the embodiment of FIG. 1;

FIG. 3 shows a cut away view of the garbage bin clip of FIG. 1 attached to a lip of a bin;

FIG. 4 shows a perspective view of a second embodiment of a garbage bin clip;

FIG. 5 shows a profile view of the embodiment of FIG. 4; and

FIG. 6 shows a cut away view of the garbage bin clip of FIG. 4 attached to a lip of a large bin.

### DETAILED DESCRIPTION OF THE INVENTION

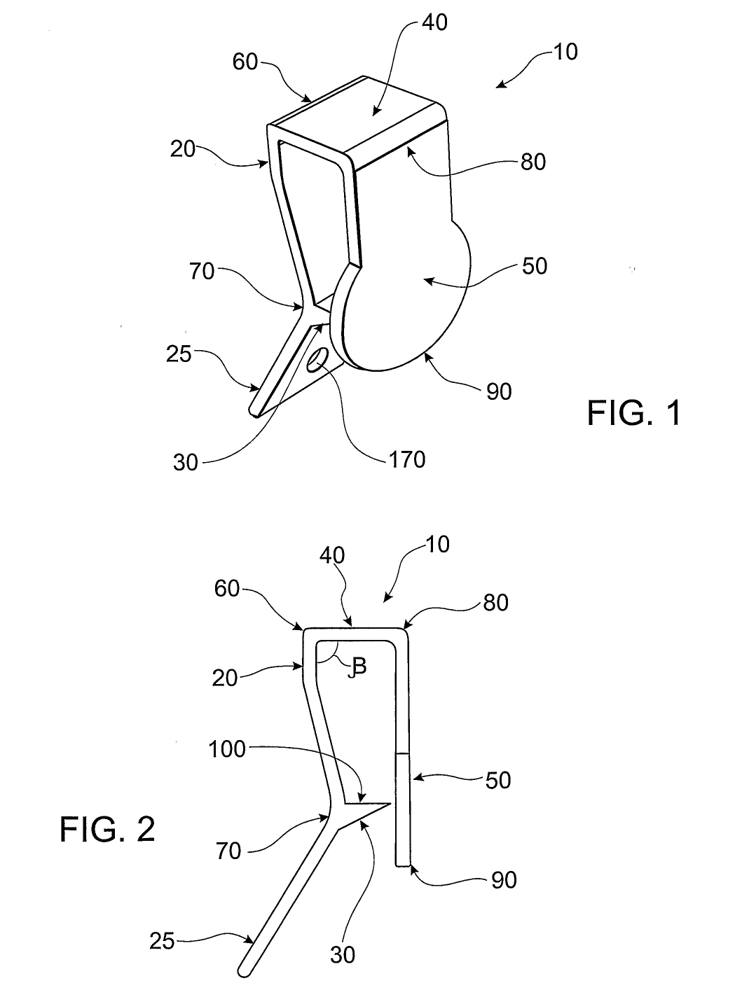

Referring to FIGS. 1 and 2, there is provided a perspective view and a profile view, respectively, of a first embodiment of a garbage bin clip 10 that incorporates an outer leg 20, a catch 30 formed as a ridge, and an inner leg 50. In the embodiment the outer leg 20 is joined to the inner leg 50 by a bridge 40. It should be appreciated that in other embodiments the outer leg 20 could be joined directly to the inner leg 50 and a hinged joint arrangement is also possible. The embodiment shown in FIG. 1 and FIG. 2 is particularly suited to household garbage bins.

The outer leg 20 is connected to an edge 60 of the bridge 40 at angle β. The outer leg 20 includes a bend 70 that is at an obtuse angle and is parallel to edge 60. A lower portion of the outer leg 20 extends away from the inner leg 50 to form a grip 25. The length of the outer leg 20 when measured from the edge 60 in the vertical axis is suitably about 30 mm. The outer leg 20, the bridge 40 and the inner leg 50 are about 2 mm thick. In the preferred embodiment the bin clip 10 is constructed from plastic that is capable of resilient deformation. It should be appreciated that in other embodiments only one of the outer leg 20, the bridge 40 or the inner leg 50 is made of resilient plastic.

The inner leg 50 is connected to an edge 80 of the bridge 40 at an angle of about 90°. The distance from edge 80 to a tip 90 of the inner leg 50 is about 30 mm and the maximum width of the inner leg 50 is in the order of 25 mm. The inner leg 50 is paddle shaped and hence broader at a lower end that is closer to tip 90 than at a second end that is closer to edge 80.

It is common for small items to be swallowed by children or animals. There is a risk that when items are swallowed that a child or animal will choke on them. The distance from edge 80 to tip 90 and the width of about 25 mm of the inner leg 50 are dimensions that are too large to be swallowed by a child or most domestic animals and hence, children and animals are unlikely to choke on the bin clip 10.

The catch 30 is integrally formed with, and extends from, a surface of the outer leg 20 that faces towards the inner leg 50. The catch 30 is situated at about 15 mm below the edge 60 where the outer leg 20 joins the bridge 40. The catch 30 extends out for approximately 3 mm from the outer leg 20 and forms a sharp edge 100.

It will be appreciated that the specific dimensions of the first embodiment are provided in order to provide an understanding of the invention as it may be applied to a specific garbage bin. The invention is not limited to the specific dimensions outlined.

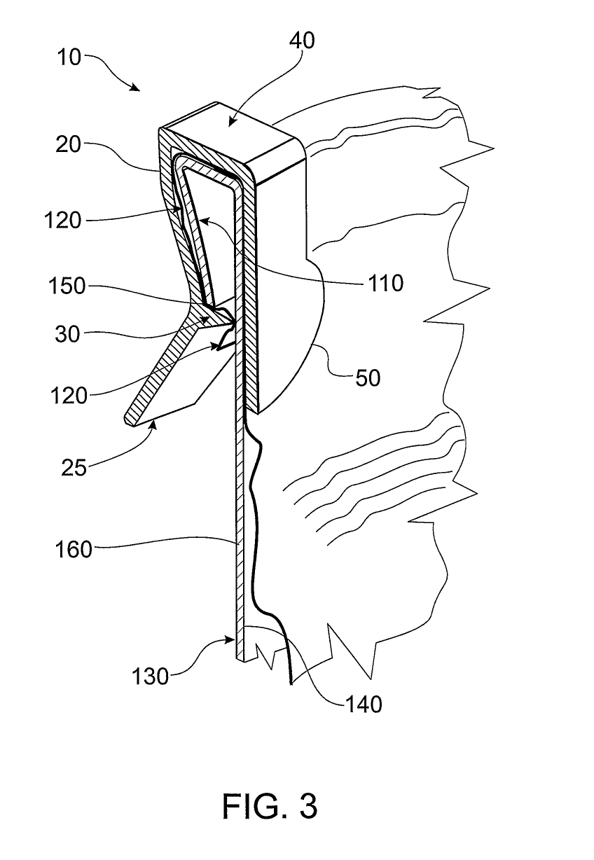

Referring to FIG. 3, there is provided a cut away view of the garbage bin clip 10 attached to a bin lip 110. A garbage bag 120 is secured between the bin lip 110 and the garbage bin clip 10. To secure the garbage bag 120 within a garbage bin 130 the garbage bag 120 is first placed inside the garbage bin 130 so that the garbage bag 120 lines the bin 130 and a portion of the garbage bag 120 lies over the bin lip 110. When the garbage bin clip 10 is secured to the bin lip 110 the inner leg 50 rests against an inner wall 140 of the garbage bin 130, with the garbage bag 120 positioned between the garbage bin clip 10 and the inner wall 140 of the garbage bin 130. Simultaneously, the outer leg 20 rests against an outer wall 160 of the bin 130 while the bridge 40 rests against a top of the bin lip 110. When the garbage bin clip 10 is successfully placed over the bin lip 110 the catch 30 catches under an outer edge 150 of the bin lip 110 to secure the garbage bin clip 10 to the bin lip 110. The feature of the catch 30 catching on the outer edge 150 of the bin lip 110 ensures that an operator does not have to reach inside the garbage bin 130 to attach or remove the clip as the catch 30 can be released from beneath the outer edge 150 by the operator grasping the grip 25 of the outer leg 20.

Also shown in FIG. 1 is an aperture 170 incorporated into the grip 25. The aperture 170 is suitable for threading string through to allow the bin clip 10 to be tied to a bin or other item to minimise the risk of losing the bin clip 10. The aperture 170 is also suitable for tying a number of bin clips together.

When an individual has the garbage bag 120 positioned within the garbage bin 130 the garbage bin clips 10 are attached by the individual holding the clip by the grip 25 of the outer leg 20 and placing the bin clip 10 onto the bin lip 110 with the inner leg 50 against the inner wall 140. When the clip is placed onto the bin lip 110 the clip deforms to allow the catch 30 to catch beneath the outer edge 150 of the lip 110. Notably the attachment process does not require that the individual attaching the bin clip 10 place their hands within the garbage bin 130.

When the individual wishes to remove garbage bag 120 they must first remove the garbage bin clips 10. The garbage bin clips 10 are best removed by grasping and applying an upward pressure to the grip 25 of the outer leg 20 in such a manner as to deform the bin clip 10 so that the catch 30 can be unhooked from beneath the outer edge 150 of the bin lip 110. When the catch 30 is unhooked the bin clip 10 can be lifted off the bin lip 110. Attaching and removing the bin clip 10 by grasping grip 25 of the outer leg 20 ensures that the individual who is placing the garbage bag in the bin 130 or removing the garbage bag 120 from the bin 130 is not exposed to bacteria that is inside the bin.

To secure a garbage bag within a garbage bin 130 at least three clips should be applied to the bin lip 110 with an evenly spaced distribution around the bin lip 110.

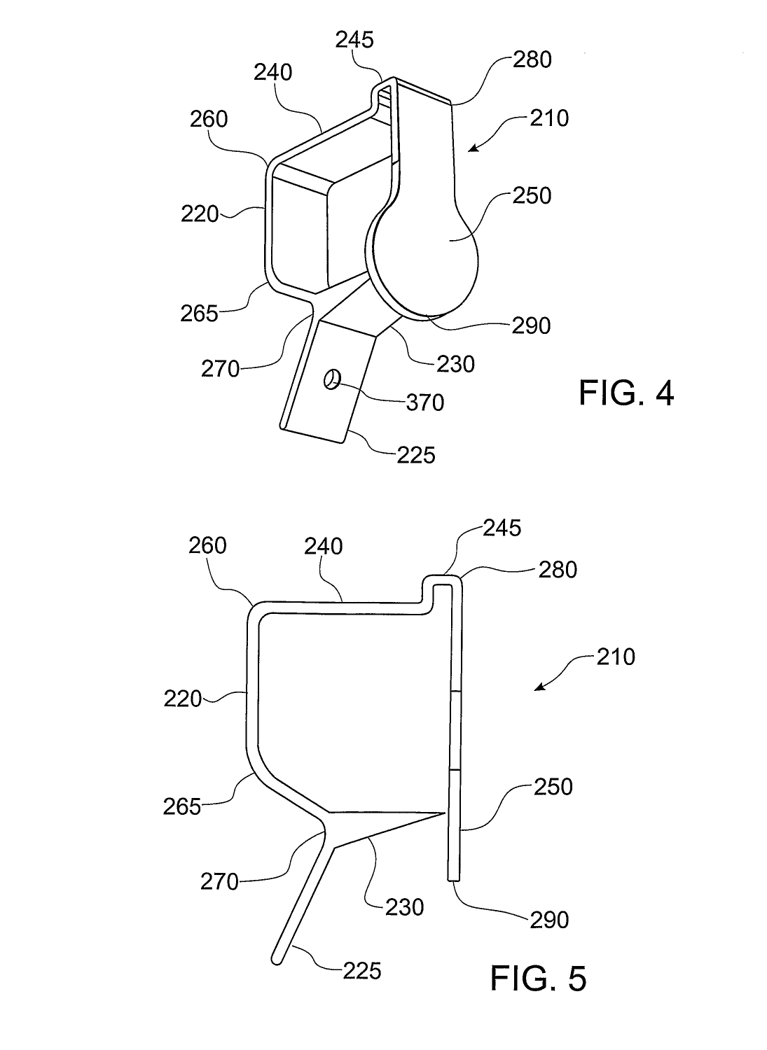

As mentioned earlier, the embodiment of FIGS. 1, 2 and 3 is particularly suited to household garbage bins and the like. FIG. 4 shows a second embodiment that is more suited for larger bins, known in some places as wheelie bins. These bins typically have a shaped bin lip that renders the bin clip of the first embodiment unsuitable.

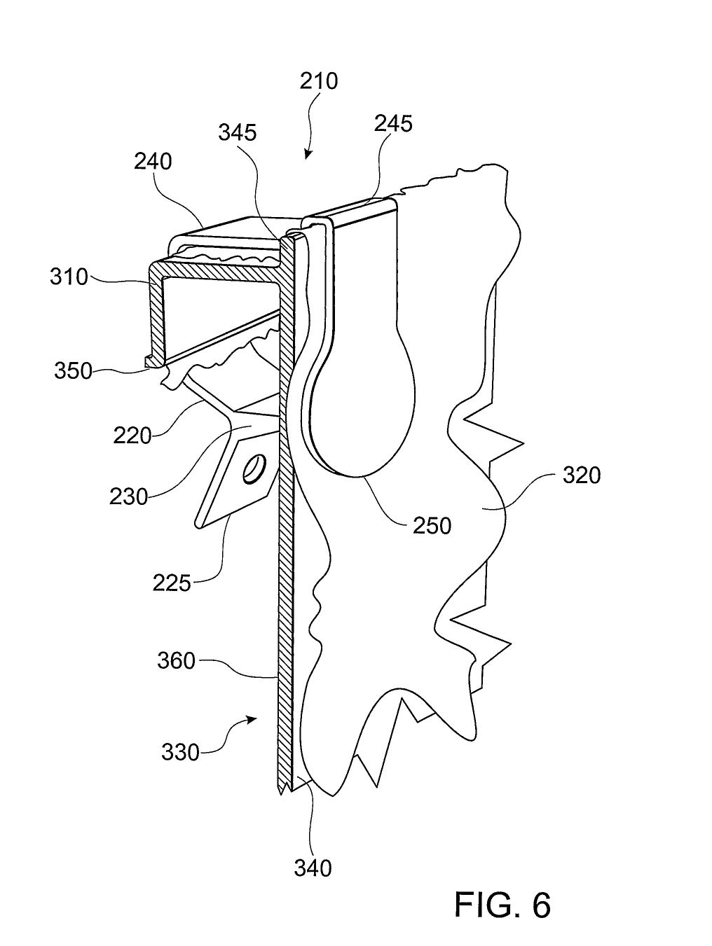

Looking at FIG. 4 and FIG. 5 there is shown a second embodiment of a garbage bin clip 210 that incorporates an outer leg 220, a catch 230 formed as a ridge, and an inner leg 250. The inner leg 250 is joined to the outer leg 220 by a bridge 240 that includes a section 245 shaped to fit over the upper edge 345 of the inner wall 340 of the bin 330, as seen most clearly in FIG. 6.

The outer leg 220 is connected to an edge 260 of the bridge 240. The outer leg has an inward bend 265 that shapes the bin clip 210 to suit the top of the bin 330. An outward bend 270 forms the grip 225. An aperture 370 is formed in the grip 225 to secure the bin clip 210 to the bin 330 if desired.

The inner leg 250 is connected to an edge 280 of the section 245. The inner leg 250 is paddle shaped so as to be broader at a lower end that is closer to tip 290 than near edge 280. The paddle shape is just one suitable shape that the inventor has found to be appropriate. Other shapes such as squares, rectangles and diamonds, will also be appropriate. The invention is not limited to any particular shape.

The catch 230 is integrally formed with the outer leg 220 and extends towards the inner leg 250. As seen in FIG. 6, the catch 230 holds the clip 210 on the lip 310 of bin 330. As with the first embodiment, a bag 320 is placed in the bin 330 and a number of clips 210 are attached by an individual holding the clip 210 by the grip 225 of the outer leg 220 and placing the clip 210 onto the bin lip 310 with the inner leg 250 against an inner wall 340. Simultaneously, the outer leg 220 rests against an outer wall 360 of the bin 330 while the bridge 240 rests against a top of the bin lip 310 with the section 245 over the upper edge 345. When the clip 210 is placed onto the bin lip 310, the clip deforms to allow the catch 230 to catch beneath the outer edge 350 of the bin lip 310.

As seen by a comparison of the first embodiment in use in FIG. 3 and the second embodiment in use in FIG. 6, the principle of use, application and removal is the same. The second embodiment demonstrates that a variation in the shape of the outer leg can adapt the bin clip for different shape bins. It will also be noted that the holding action of the bin against the bag occurs primarily between the inner leg and the inner wall of the bin. But there is also a holding action between the clip and the bin lip and the clip and the outer bin wall.

Hence, the method and apparatus of the present invention provides a solution to the problems of securing garbage bags within garbage bins and minimizes exposure to bacteria from garbage bins by virtue of bin clips having a grip formed in an outer leg that allows an individual to attach and remove the bin clip without placing their hands in the bin and a catch formed from an outer leg that secures the bin clip to the lip of the garbage bin.

Throughout the specification the aim has been to describe the invention without limiting the invention to any one embodiment or specific collection of features. Persons skilled in the relevant art may realize variations from the specific embodiments that will nonetheless fall within the scope of the invention.

1. A clip comprising:
an inner leg joined to an outer leg;
a grip formed by a lower portion of the outer leg extending away from the inner leg; and
a catch formed by a ridge on a surface of the outer leg facing the inner leg;
wherein the outer leg is resiliently deformable with respect to the inner leg.

2. The clip of claim 1 further comprising a bridge joining the inner leg and the outer leg.

3. The clip of claim 2 wherein the bridge is shaped to match a shape of an article to which the clip is to be applied.

4. The clip of claim 1 wherein at least part of the clip is formed from resiliently deformable plastics material.

5. The clip of claim 1 further comprising an aperture in the grip.

6. The clip of claim 1 wherein the grip is formed below a bend in the outer leg.

7. The clip of claim 1 wherein the inner leg comprises a paddle shaped portion.

8. The clip of claim 1 wherein the clip has a flat upper surface and a sloping lower surface.

9. A method of securing a garbage bag within a garbage bin including the steps of:
placing the garbage bag within the garbage bin such that at least a portion of the bag drapes over a lip of the garbage bin; and
forcing at least one clip over the lip using a grip that is external of the bin, so that an inner leg of the clip clamps the garbage bag against an inner surface of the garbage bin and a catch formed on an outer leg of the clip catches under the lip to hold the clip in place.

10. A method of removing a garbage bag from within a garbage bin, including the steps of:
removing one or more clips from a lip of the garbage bin by holding the clip by a grip that is external of the bin and applying pressure so as to resiliently deform an outer leg of the clip with respect to an inner leg of the clip to release a catch from beneath an outer edge of the lip and lifting the clip from the lip; and
removing the garbage bag from the garbage bin.
